(19) United States
(12) Patent Application Publication
(10) Pub. No.: US 2026/0296254 A1
(43) Pub. Date: Oct. 1, 2026

(54) SYSTEMS AND METHODS FOR CHARGING ELECTRIC VEHICLES WITH CHARGING STATIONS IN VARIOUS CONNECTIVITY MODES

(71) Applicant: AmpUp, Inc., Santa Clara, CA (US)

(72) Inventors: Thomas Shaofeng Sun, Santa Clara, CA (US); Li Zhang, Santa Clara, CA (US)

(73) Assignee: AmpUp, Inc., Santa Clara, CA (US)

(21) Appl. No.: 19/482,042

(22) PCT Filed: May 31, 2024
(86) PCT No.: PCT/US24/32145

§ 371 Date: Nov. 6, 2025

Related U.S. Application Data
(60) Provisional application No. 63/506,135, filed on Jun. 4, 2023.

(51) Int. Cl. B60L 53/66; B60L 53/18; B60L 53/30

(52) U.S. Cl. CPC B60L 53/66; B60L 53/18; B60L 53/305; B60L 2240/72; B60L 2250/16

(57) ABSTRACT

A system and method for charging of an electric vehicle in locations with low connectivity, the method comprising: when at least one of an EVSE unit and a user device of a user is in a first location providing a first level of connectivity with a network below a threshold: at a first time point, receiving a check-in request at the EVSE unit by the user associated with the electric vehicle, wherein the check-in request comprises a communication between the EVSE unit and a user device of the user, the communication comprising a set of identifying parameters; upon verification of the set of identifying parameters of the check-in request, initiating charging of the electric vehicle, through a cable coupled between the EVSE unit and the electric vehicle, at a second time point later than the first time point.

### CROSS-REFERENCE TO RELATED APPLICATIONS

This application claims the benefit of U.S. Provisional Application No. 63/506,135, filed on Jun. 4, 2023, and is a submission under 35 U.S.C. 371 based on PCT/US24/32145 filed on May 31, 2024, which are each incorporated in its entirety herein by this reference.

### TECHNICAL FIELD

The disclosure generally relates to fields pertaining to charging of electric vehicles.

### BACKGROUND

Traditional electric vehicle service equipment (EVSE) units (e.g., chargers) typically rely upon connected/online operations, in order to operate smoothly with respect to initiating and/or completing charging sessions. However, flaws inherent to locations of EVSE unit installation can produce operational inefficiencies and poor user experiences, associated with poor connectivity and other factors. Thus, there is a need in the field of electric vehicle charging for improved systems and methods for providing reliable, robust, and secure charging of electric vehicles.

### BRIEF DESCRIPTION OF THE FIGURES

FIGS. 1A-1B depict flowcharts and schematics of embodiments of a method for electric vehicle charging in different connectivity modes.

FIGS. 2A-2C depict variations of check-in request operations associated with a method and system for electric vehicle charging in different connectivity mode.

FIGS. 3A-3D depict an example of a workflow for initiating charging with respect to different connectivity modes of a user device involved in the charging process.

FIGS. 4A-4C depict variations of method steps involved in initiating a charging session when connectivity is below a threshold level.

FIG. 5 depicts an embodiment of a system for electric vehicle charging in different connectivity modes.

FIG. 6 depicts an embodiment of a computer system involved in executing a method for electric vehicle charging in different connectivity modes.

### INCORPORATION BY REFERENCE

All publications, patents, and patent applications mentioned in this specification are herein incorporated by reference in their entireties for all purposes and to the same extent as if each individual publication, patent, or patent application was specifically and individually indicated to be incorporated by reference.

Furthermore, where a range of values is provided, it is understood that each intervening value, between the upper and lower limit of that range and any other stated or intervening value in that stated range is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either both of those included limits are also included in the invention.

### DESCRIPTION OF THE EMBODIMENTS

The following description of the embodiments (e.g., including variations of embodiments, examples of embodiments, specific examples of embodiments, other suitable variants, etc.) is not intended to be limited to these embodiments, but rather to enable any person skilled in the art to make and use the invention(s).

### 1. Benefits and Applications

The invention(s) described can confer several benefits over conventional systems and methods.

For instance, the invention(s) provide a mechanism for charging session initiation and/or completion for chargers that are subject to low connectivity or are otherwise offline (e.g., in underground garages or sites, in geographic locations having low cellular signal, etc.), thereby streamlining charging operations and providing an improved user experience.

In one exemplary case, the invention(s) can provide solutions to users of applications for charging electric vehicles, where such users may encounter issues with charging stations, such as hardware faults, internet connectivity issues, and/or mismatches between plugs and chargers/EVSE units. These issues may cause inconvenience and reduce the effectiveness of the charging process.

In other use cases, the invention(s) provide users with mechanisms for easily reporting any issues with charging stations/EVSE units, quickly resolving hardware faults, receiving notifications about connectivity with telecommunications networks, and selecting a correct charging plug to avoid charging errors.

The invention(s) also provide a mechanism for energy output/use optimization and load management for a set of chargers/EVSE units at a site associated with low connectivity of offline operations. As such, the invention(s) provide solutions that support broader charging infrastructure adoption and while enabling participation in utility demand response programs by site and/or charger managers.

The invention(s) provide charging architecture, with software and hardware components, for utilities companies to properly distribute load and/or shed load in response to spikes in demand, non-uniform demand (e.g., in relation to time of day, in relation to seasons, in relation to weather-related events, etc.), increases in demand due to additional vehicles, systems, and devices requiring power, and/or other factors, even when chargers are offline or are operating in low connectivity modes.

The invention(s) also include systems and methods for management of load distribution and shedding, with subsystems configured to properly incentivize end users to behave in manners that reduce demand under various circumstances.

The invention(s) also include architecture for generation of training and test data, for training of models, in various phases, to optimize control of load distribution and shedding in response to a wide range of demand events, and/or in relation to offline charger modes.

The invention(s) also support green initiatives, with respect to demand shedding, adoption of clean electricity sources, and implementation of protocols to promote use of clean electricity and improved user behaviors to reduce carbon emissions.

The invention(s) can additionally or alternatively include electronic elements with associated software and/or firmware architecture for prevention of hacking and/or forms of cyber attacks against utilities companies and infrastructures.

The invention(s) can additionally or alternatively provide other suitable benefits.

Methods and systems described can additionally or alternatively be implemented and/or integrated with embodiments, variations, and examples of invention(s) described in U.S. application Ser. No. 16/983,175, which is herein incorporated in its entirety by this reference.

### 2. Method

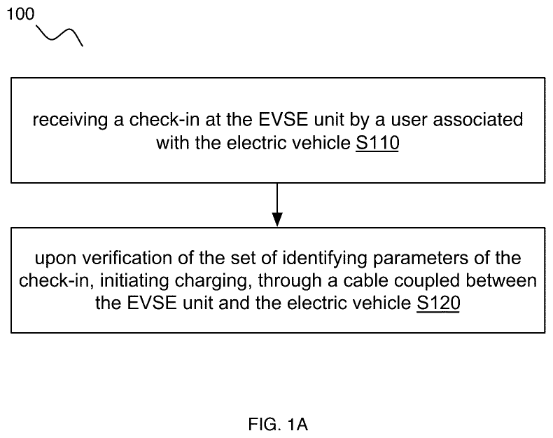

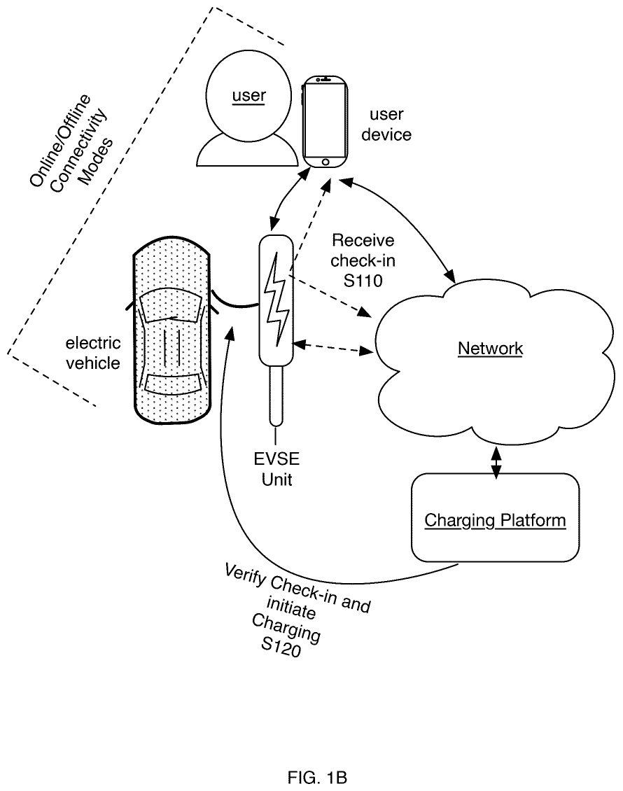

As shown in FIGS. 1A and 1B, an embodiment of a method 100 for charging an electric vehicle at an Electric Vehicle Service Equipment (EVSE) unit comprises: receiving a check-in request at the EVSE unit by a user associated with the electric vehicle S110, wherein the check-in request comprises a communication between the EVSE unit and a user device of the user, the communication comprising a set of identifying parameters; upon verification of the set of identifying parameters of the check-in request, initiating charging, through a cable coupled between the EVSE unit and the electric vehicle S120.

In variations, the method 100 can include supporting offline operation modes associated with either or both the EVSE unit and the user device (e.g., modes where signal strength for communications with a wireless network are below a threshold level). In particular, the user device associated with Steps S110 and S120 can be linkable to a wireless network (e.g., telecommunications network) and operate in an online mode and in an offline mode, where linking with the wireless network is involved in relation to verification of the set of identifying parameters of the check-in request. In the online mode, the user device is connected to the wireless network, and in the offline mode, the user device is attempting communication with the wireless network, with signal strength below a threshold level. Transitioning to the offline mode can occur when the user is in a cellular dead zone (e.g., in an underground parking garage), when there is a disruption in connectivity caused by components of the wireless network, when the user device is switched to the offline mode (e.g., in “Airplane mode”), or in another suitable manner.

Embodiments of the method 100 function to provide a mechanism for charging session initiation and/or completion for chargers that are subject to low connectivity or are otherwise offline (e.g., in underground garages or sites, in geographic locations having low cellular signal, etc.), thereby streamlining charging operations and providing an improved user experience. Embodiments of the method 100 also function to provide a mechanism for energy output/use optimization and load management for a set of chargers/EVSE units at a site associated with low connectivity of offline operations. As such, the invention(s) provide solutions that support broader charging infrastructure adoption and while enabling participation in utility demand response programs by site and/or charger managers.

The method 100 functions to provide charging architecture solutions, with software and hardware components, for utilities companies to properly distribute load and/or shed load in response to spikes in demand, non-uniform demand (e.g., in relation to time of day, in relation to seasons, in relation to weather-related events, etc.), increases in demand due to additional vehicles, systems, and devices requiring power, and/or other factors, even when chargers are offline or are operating in low connectivity modes.

The method 100 can be executed by embodiments, variations, and examples of systems or subsystems described in more detail below, or another suitable system.

### 2.1 Method-Charger Check-In Request With Offline Connectivity Modes

Step S110 recites: receiving a check-in request at the EVSE unit by a user associated with the electric vehicle S110, wherein the check-in request comprises a communication between the EVSE unit and a user device of the user. Step S110 functions to detect a check-in request at the EVSE unit for a scheduled charging session (e.g., a reservation for a charging station at the location in advance) or an ad-hoc charging session, in order to initiate charging in a user-focused manner (e.g., user-friendly manner) in subsequent steps of the method 100. Step S110 can include receiving a check-in request during offline connectivity modes and/or during online connectivity modes of either or both the EVSE unit and the user device of the user, where offline connectivity modes characterize operational states of user devices and/or EVSE units that have signal strength for connecting to a telecommunications network or other wireless/wired network below a threshold level. Charging sites that are subject to low connectivity or are otherwise offline can be associated with one or more of: underground garages or sites, sites having shielding objects (e.g., walls, high buildings, etc.) in the vicinity of such sites, geographic locations having low cellular signal, offline modes (e.g., Airplane mode, standalone mode, flight mode, etc.) of user devices, low-battery charge operation modes of user devices involving reduced functionality of such user devices, disturbances to telecommunications networks hardware and/or software components, shielding of user devices, and/or other factors. In variations where signal strength for communications with the telecommunications network is below a threshold and/or when the EVSE unit is in a location (e.g., a first location) providing a first level of connectivity with a network below a threshold, the EVSE unit can still be structured to communicate with the platform for electric vehicle charging, through the telecommunications network (or other wireless/wired network), using hardware components (e.g., Ethernet, a router) that have a cellular Subscriber Identity Module (SIM) component wired to a location with suitable signal strength (i.e., signal strength above a threshold level).

If the check-in request is received during online connectivity modes in Step S110, charging can be initiated and executed according to embodiments, variations, and examples of methods described in one or more of: U.S. patent application Ser. No. 16/983,175 filed on Aug. 3, 2020, and U.S. patent application Ser. No. 17/163,638 filed on Feb. 1, 2021, each of which is incorporated herein in its entirety by this reference.

If the check-in request is received when the EVSE unit is in a location (e.g., first location) providing a first level of connectivity with a network below a threshold, the method 100 can still be executed according to methods described herein.

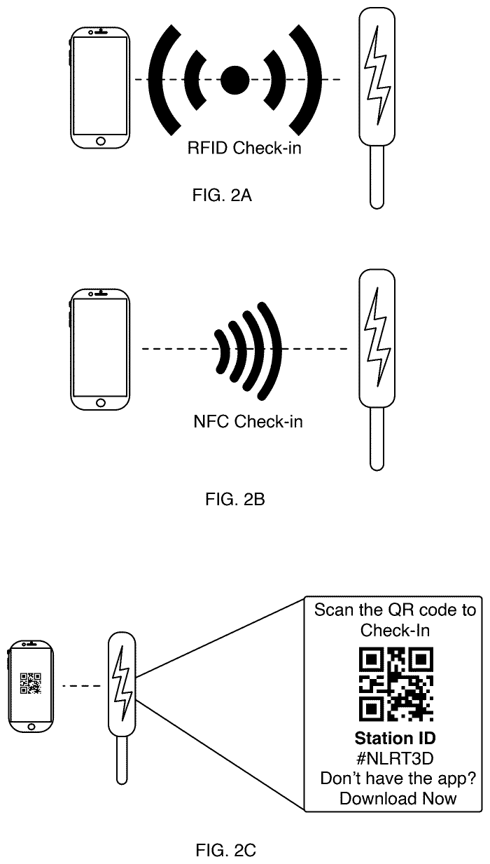

In variations, one of which is shown in FIG. 2A, the check-in request can involve radio-frequency identification (RFID) elements and communication protocols by which the EVSE unit and the user device operate to transmit and receive digital data. As such, Step S110 can include promoting communication between a radio-frequency identification (RFID) element of the user device of the user, and the EVSE unit.

The RFID element(s) can include a transponder, a receiver, and a transmitter, where an RFID tag of a user device is structured to transmit digital data in response to being triggered by an interrogation pulse of a reader (e.g., of the EVSE unit/charger). Alternatively, an RFID tag of an EVSE unit/charger can be structured to transmit digital data in response to being triggered by an interrogation pulse of a reader (e.g., of the user device). RFID tags implemented can include passive tags that are powered by interrogating radio waves of readers, and/or active tags that are coupled to a power source (e.g., battery), with capability for greater range communications. RFID tags implemented can be read-only, or have read/write functionality. RFID systems associated with the check-in request of Step S110 can be passive reader active tag (PRAT) systems, active reader passive tag (ARPT), or active reader active tag (ARAT) systems. RFID systems can operate in low frequency bands (e.g., 120-150 kHz), high frequency bands (e.g., 13.56 MHz), ultrahigh frequency bands (e.g., greater than 100 MHz), microwave bands (e.g., greater than 2000 MHz), mm-wave bands, teraherz bands (e.g., as in teraherz frequency identification).

Exemplary RFID elements can be incorporated into user devices and objects, including one or more of: employee badges (e.g., a fleet employee badge, a badge associated with a fleet operation), credit cards, driver's licenses, public transportation passes, other cards, stickers, identification objects (e.g., ID cards, passports, etc.), electronic devices (e.g., mobile devices), keys (e.g., lodging key such as a hotel key, car key), fobs, clothing, or other objects (e.g., implanted RFID elements). Such RFID elements can be linked to an account of the user within a platform for charging electric vehicles, such that the user can use any associated object to initiate a charging session. Thus, any form of RFID linking and initiation can be included in systems described and/or implemented according to methods described.

In variations, one of which is shown in FIG. 2B, the check-in request can involve near-field communication (NFC) elements and communication protocols by which the EVSE unit and the user device operate to transmit and receive digital data. As such, receiving the check-in request in Step S110 can include promoting communication between a near-field communication (NFC) element of the user device of the user, and the EVSE unit. The NFC elements can include inductive coupling elements (e.g., antennas) between NFC-enabled EVSE units and NFC-enabled user devices, operating according to ISO/IEC 18092/ECMA-340 standards, ISO/IEC 21481/ECMA-352 standards, ISO/IEC 14443 standards, FeliCa standards, or other standards. The check-in request at the EVSE unit can involve a communication between an active initiator device and either a passive target device that can modulate an incident carrier field of the initiator device, or an active target device that can generate its own field. In embodiments involving active NFC devices, such NFC devices can include NFC card emulation functionality, NFC reader/writer functionality, and NFC peer-to-peer functionality for ad hoc communications.

In variations, the check-in request can involve entry of a code corresponding to the set of identifying parameters, a user account, and/or a charging session of the user, where entry of the code can be provided at a user interface (e.g., key pad, touch screen, etc.) of the EVSE unit and/or the user device (e.g., through user interface described below).

In variations, one of which is shown in FIG. 2C, the check-in request can involve tag scanning, where exemplary tags can include quick response (QR) codes or other barcodes that are machine-readable (e.g., optical images) that encode information. As such receiving the check-in request can include a tag scanning event. Encoded information can include data for identifiers, where the identifiers can point to platform applications or websites to perform a process. Barcodes can be structured to encode according to numeric, alphanumeric, byte/binary, and/or kanji modes. In variations, one or more barcodes can be coupled to the EVSE unit, which can be scanned by a camera or other reader of the user device, as a step to initiate charging after verifying identifying parameters of the check-in request, through the platform, according to Step S120 (described in further detail below).

In embodiments of the check-in request, regardless of mechanism (e.g., RFID, NFC, manual code entry, barcode scanning, etc.), the check-in request communication between devices can include a set of identifying parameters. Exemplary identifying parameters can include one or more of: an identifier (e.g., international mobile equipment identity (IMEI), serial number, serial code, etc.) of the EVSE unit and/or the user device; parameters of signals transmitted between an RFID transmitter and a receiver; parameters of signals transmitted between an NFC transmitter and a receiver; EVSE unit station identifiers (e.g., in relation to a charging site, etc.); parameters of the intended charging session (e.g., date, time, duration, user, electric vehicle, etc.); parameters of the electric vehicle being charged, private keys of the EVSE unit and public keys for authentication of a charging session, where private and public keys are related by a hashing function; an electronic product code (EPC); or other identifying parameters.

Identifying parameters can be static, or can be dynamically changing for enhanced security of charging sessions.

In embodiments, receiving the check-in request can include providing a user interface S112, which can function to provide users with means to communicate with a platform for coordinating charging sessions between EVSE units and users through associated user devices, and/or otherwise using reservation requests, check-in requests, payment, authentication, and/or other suitable processes. The user interface provided in Step S112 can also be used to initiate the check-in request from the user device (e.g., by scanning a barcode through a camera of the user device according to permissions granted to the user interface, by positioning RFID elements/NFC elements of the user device in proximity to the EVSE unit, etc.)

Providing a user interface in step S112 can include providing a user interface via a mobile application for a user device, but one or more user devices can additionally or alternatively be provided through any suitable applications and/or for any suitable devices. Providing the user interface in Step S112 can include providing a means (e.g., graphical map, list, etc.) for viewing EVSEs and/or charging locations on a map (e.g., where reservation requests can be submitted for such EVSEs and/or charging locations; where information can be provided to the user regarding the EVSEs and/or charging locations; etc.).

In a specific example, Step S112 can include providing a user interface at a mobile application for a user device, where the user interface includes a set of charging location indicators (e.g., graphical indicators on a graphical map; any suitable indicators; etc.) associated with a set of EVSEs including the EVSE, where the reservation request is associated with a charging location indicator of the set of charging location indicators, where the charging location indicator is associated with the EVSE. User account aspects, such as linked objects (e.g., RFID objects, NFC objects), payment methods, charging sessions (e.g., reserved charging sessions), demand response events, user groups (e.g., employee groups, fleet groups, etc.) and/or other aspects can also be accessed and/or modified through the user interface. However, providing one or more user interfaces in Step S112 can be performed in another suitable manner, embodiments, variations, and examples of which are provided in Applications incorporated by reference above.

2.2 Method-Charging Execution with Offline Connectivity Modes

Step S120 recites: upon verification of the set of identifying parameters of the check-in request, initiating charging, through a cable coupled between the EVSE unit and the electric vehicle. Step S120 functions to initiate a charging session in a user-focused manner (e.g., user-friendly manner), with functionality for enabling charging sessions even when the user attempts to check-in request during offline connectivity modes of either or both the EVSE unit and the user device of the user, where offline connectivity modes characterize operational states of user devices and/or EVSE units that have signal strength for connecting to a telecommunications network or other wireless/wired network below a threshold level (e.g., modes where a level of wireless connectivity with a network is below a threshold). In variations, verification of the set of identifying parameters in Step S120 can be executed with verification when the user device returns to a second location providing a second level of connectivity with the network above the threshold.

In relation to step S120, charging can initiate when the user/user device is in proximity to the EVSE unit during the verification process, or when the user/user device is not in proximity to the EVSE unit during the verification process (e.g., when the user device returns to an environment/second location or the user device is transitioned to a state where communication with the telecommunications network or other wireless/wired network has an associated signal strength above a threshold level).

Exemplary offline or low connectivity modes can include modes in which wireless connectivity with a network is below “4 bars”, “3 bars”, “2 bars”, “1 bar”. Exemplary offline or low connectivity modes can include modes in which SOS is indicated for the network. Exemplary offline or low connectivity modes can include modes that are 2G, 3G, or 4G. Exemplary offline or low connectivity modes can include modes in which packet or other data transmission is less than 70%, less than 60%, less than 50%, less than 40%, less than 30%, less than 20%, less than 10%, less than 5%, less than 4%, less than 3%, less than 2%, less than 1% or less than a maximum specified data or packet transmission capacity of network systems involved.

Additionally or alternatively, the check-in request can be received at a first time point or within a first time window (e.g., when the user device is used to check-in with the EVSE), and initiating charging can be performed at a second time point or time window (e.g., later than the first time point or time window). The attempt for initiating charging at the second time point or time window can be performed automatically (e.g., initiating charging is automatically attempted at a frequency or with a time lag). Alternatively, the attempt for initiating charging can occur once the level of connectivity satisfies a threshold condition.

In a first variation, where the set of identifying parameters is communicated using RFID elements of the user device and the EVSE unit, verification of the set of identifying parameters of the check-in request can be accomplished by the charging platform while the user/user device is at (e.g., in proximity to) the EVSE unit, given direct communication of parameters using the RFID elements, and for an EVSE unit that is in communication with the platform through a connection (e.g., Subscriber Identity Module (SIM) component with a wired connection to an area with suitable signal strength/a level of connectivity above the threshold) through the network. Verification of the set of identifying parameters of the check-in request can thus include communicating the set of identifying parameters through the network using a Subscriber Identity Module (SIM) component with a wired connection to a second location having a level of connectivity to the network above the threshold, or using another functionally identical or similar component. As such, initiation of charging can be executed proximal in time to when the user checks in at the EVSE unit for a charging session, even when the user device and the EVSE unit are both in locations providing a level of connectivity below a threshold.

In a second variation, where the set of identifying parameters is communicated using NFC elements of the user device and the EVSE unit, verification of the set of identifying parameters of the check-in request can be accomplished by the charging platform while the user/user device is at (e.g., in proximity to) the EVSE unit, given direct communication of parameters using the NFC elements, and for an EVSE unit that is in communication with the platform through a connection (e.g., SIM component with a wired connection to an area with suitable signal strength). As such, initiation of charging can be executed proximal in time to when the user checks in at the EVSE unit for a charging sessions. Verification of the set of identifying parameters of the check-in request can thus include communicating the set of identifying parameters through the network using a Subscriber Identity Module (SIM) component with a wired connection to a second location having a level of connectivity to the network above the threshold, or using another functionally identical or similar component. As such, initiation of charging can be executed proximal in time to when the user checks in at the EVSE unit for a charging session, even when the user device and the EVSE unit are both in locations providing a level of connectivity below a threshold.

In a third variation, where the set of identifying parameters is communicated using manual code entry (e.g., manual entry of an authentication code) at a user interface of the user device and/or the EVSE unit, verification of the set of identifying parameters of the check-in request can be accomplished by the charging platform while the user is at (e.g., in proximity) the EVSE unit, given direct communication of parameters by manual code entry, and for an EVSE unit that is in communication with the platform through a connection (e.g., SIM component with a wired connection to an area with suitable signal strength). Verification of the set of identifying parameters of the check-in request can thus include communicating the set of identifying parameters through the network using a Subscriber Identity Module (SIM) component with a wired connection to a second location having a level of connectivity to the network above the threshold, or using another functionally identical or similar component. As such, initiation of charging can be executed proximal in time to when the user checks in at the EVSE unit for a charging session, even when the user device and the EVSE unit are both in locations providing a level of connectivity below a threshold.

In a fourth variation, where the set of identifying parameters is communicated through the network upon scanning a tag (e.g., QR code, other barcode) coupled to the EVSE unit, verification of the set of identifying parameters of the check-in request can be accomplished by the charging platform when the user/user device is away from (e.g., no longer in proximity to) the EVSE unit and the user device is again in communication with the telecommunications network or other wireless/wired network. In this scenario, the user device can be in an online mode and connected to the telecommunications network or other wireless/wired network, with signal strength above a threshold level for communications. The online mode can be associated with one or more of: a return to an above-ground area with adequate cellular signal strength, a transition of the user device out of an offline mode (e.g., Airplane mode, flight mode, sleep mode, on-mode, etc.), a transition of the user device out of a low-power mode having reduced functionality (e.g., upon charging, upon transitioning between power mode settings), a return of the telecommunications network to an operational state (e.g., after a disruption), a transition to a wireless network connection, or another scenario.

The fourth variation of Step S120 can involve buffering of the scan of the barcode (e.g., QR code, other barcode), where the user device, by way of the user interface (e.g., charging mobile application) executing on the user device continues to buffer and re-attempt verification of parameters for charging activation by the EVSE unit, with successful verification and initiation of charging once the user device is transitioned out of an offline mode to a connected mode (e.g., with signal strength above a threshold level, characterized by connection with the network) with respect to a cellular network, a WiFi network, or other network.

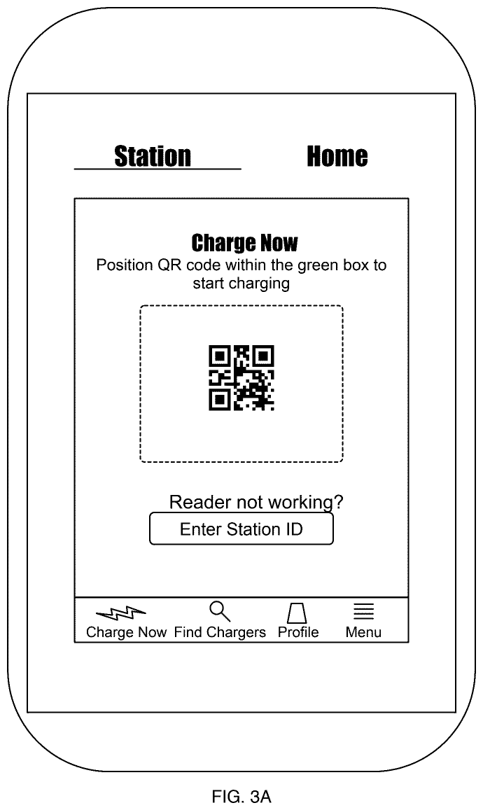

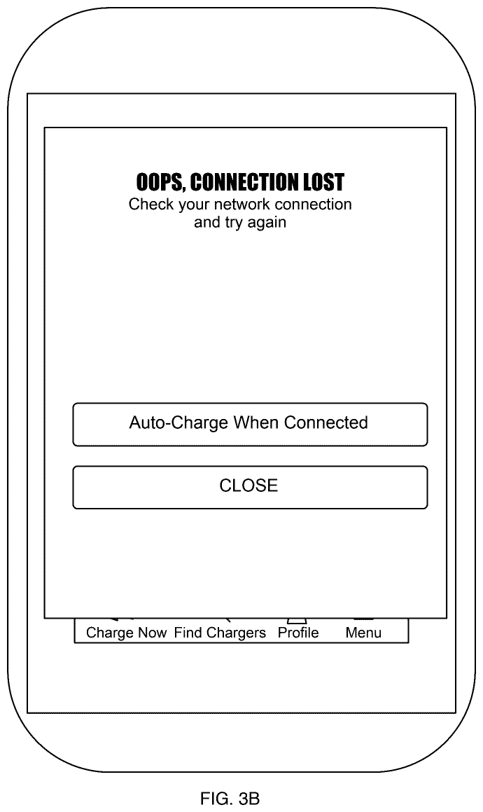

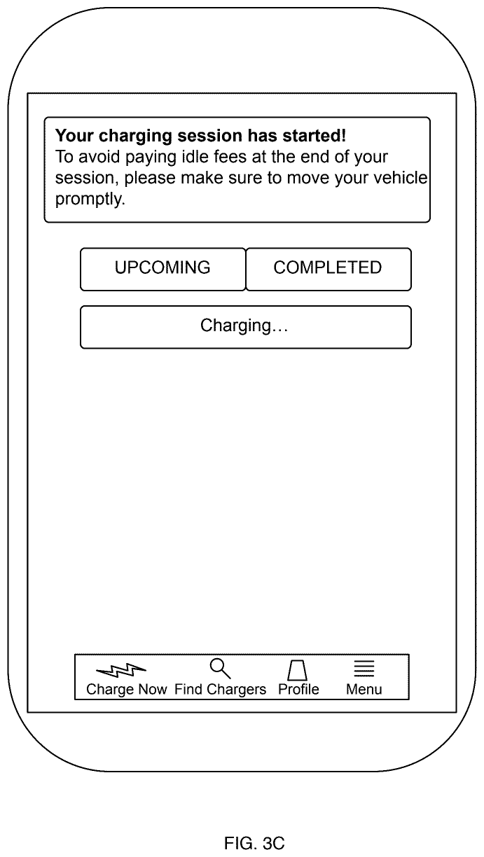

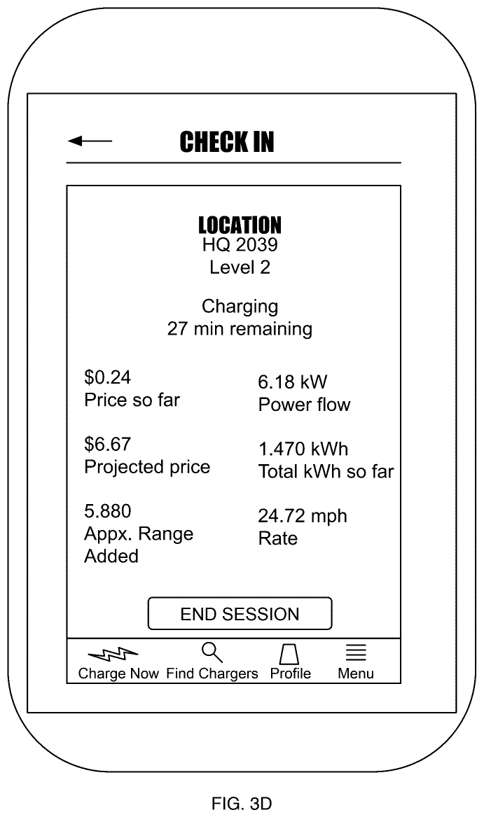

A specific example of the fourth variation is shown in FIG. 3A through FIG. 3D, where, upon scanning of a barcode (FIG. 3A) using the user interface of the mobile application executing on the user device, upon detection that the user device is in an offline mode (and presentation of a notification to the user, through the user device, that the user device is in an offline mode), the mobile application comprises architecture for presenting the user with the option to initiate charging automatically once the user device is in an online mode again (FIG. 3B). The user device, with mobile application for charging, then continues to buffer the scan of the barcode, and when the user device has returned to an online mode with signal strength above a threshold level, charging is initiated according to Step S120 through a cable connected between the EVSE unit and the electric vehicle associated with the user, and the user device presents a notification that charging has initiated (FIG. 3C). The mobile application in the example includes functionality for presenting parameters of the charging session (e.g., charging location, charger type, duration of charging, charging cost to current time point, projected charging cost, power flow characteristics, total power output, rate of charge, and estimations of range added), with notifications/reminders to retrieve the electric vehicle at the end of the charging session, and with the option to end the charging session, as shown in FIG. 3D.

In relation to the embodiments, variations, and examples described, verification of the set of identifying parameters can thus occur when the user device is at a second location having suitable connectivity, and the EVSE unit is at a first location having unsuitable connectivity. In relation to the embodiments, variations, and examples described, verification of the set of identifying parameters can thus additionally or alternatively occur when the user device and the EVSE unit are at a first location having unsuitable connectivity. In relation to the embodiments, variations, and examples described, verification of the set of identifying parameters can thus additionally or alternatively occur when the user device and the EVSE unit are at a second location having suitable connectivity.

Initiating charging in Step S120 can involve charging with load distribution and management aspects (e.g., in relation to demand response events, in relation to fleet charging operations, in relation to group charging operations, in relation to pricing structures, etc.), charging session duration aspects, charging session price aspects, charging session power output (total output, rate, etc.) aspects, charging session range aspects (e.g., range for mission, range for route determined with vehicle telematics, etc.), and other aspects, embodiments, variations, and examples of which are described in Applications incorporated by reference. Charging can be performed with devices described in PCT Application No. PCT/US22/32272 filed on Jun. 3, 2022 and titled “Systems and Methods for Enabling Reliable and Secure Charging of Electric Vehicles”, which is incorporated in its entirety herein by this reference.

2.3 Method-Charging with Improved User Experience

For embodiments of Step S120 involving buffering of operations (e.g., buffering scanned barcodes and processing of scanned barcodes) for verification and initiation of charging, the method 100 can include steps that provide a positive user experience.

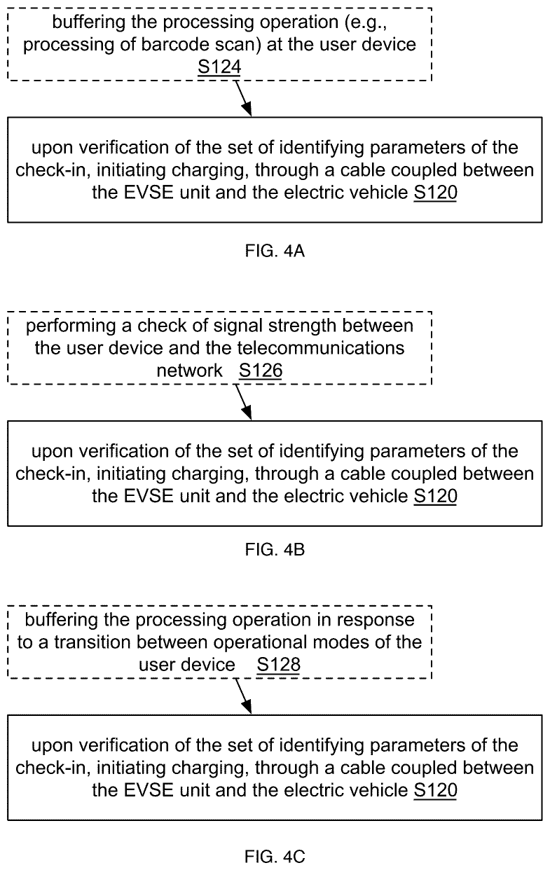

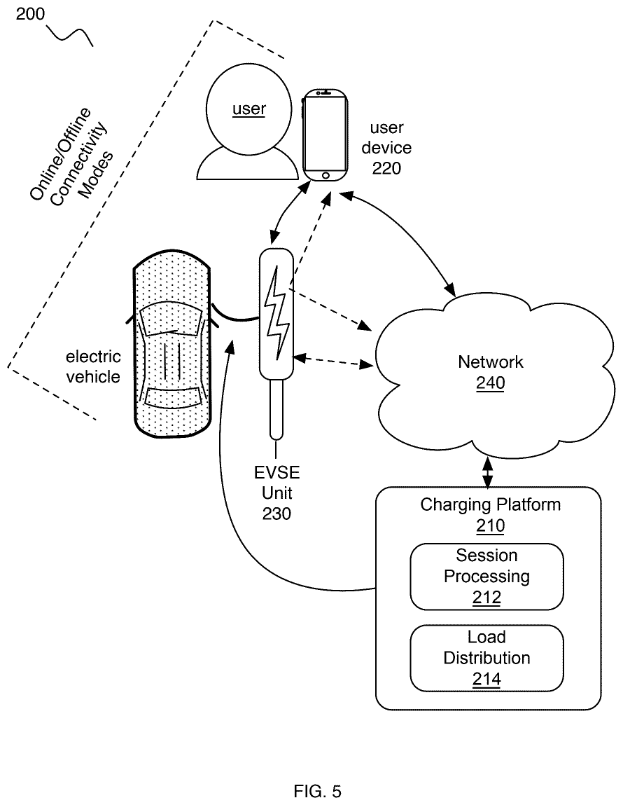

For instance, in one embodiment shown in FIG. 4A, the method 100 can include buffering the processing operation at the user device at a first frequency S124, in order to prevent excessive drain of battery charge state of the user device. The first frequency can be a frequency of: once every second, once every 30 seconds, once every minute, once every 5 minutes, once every 10 minutes, etc.). The first frequency can alternatively be a non-constant frequency. For instance, if sensors (e.g., motion sensors, GPS systems, RFID transmissions/data receipts with other RFID objects, etc.) of the user device or another device associated with the user detect movement (e.g., the user is moving away from the EVSE unit to an area with better signal strength), the method can include: increasing the frequency of buffering in response to detection of movement of the user device (e.g., through motion sensors, such as accelerometer components of the user device); and upon verification according to Step S120, initiating charging.

Additionally or alternatively, in one embodiment shown in FIG. 4B, the method 100 can include performing a check of signal strength between the user device and the telecommunications network (or other wireless/wired network) at a second frequency prior to buffering the processing operation S126, in order to prevent excessive drain of battery charge state of the user device (by checking signal strength before buffering). The second frequency can be a frequency of: once every second, once every 30 seconds, once every minute, once every 5 minutes, once every 10 minutes, etc.). The first frequency can alternatively be a non-constant frequency. For instance, if sensors (e.g., motion sensors, GPS systems, RFID transmissions/data receipts with other RFID objects, etc.) of the user device or another device associated with the user detect movement (e.g., the user is moving away from the EVSE unit to an area with better signal strength), the method can include: increasing the frequency of checks of signal strength in response to detection of movement of the user device; and upon verification according to Step S120, initiating charging.

Additionally or alternatively, in one embodiment shown in FIG. 4C, the method 100 can include buffering the processing operation in response to a transition between operational modes of the user device S128, where the operational modes can include one or more of: an Airplane mode/flight mode/offline mode; a low-power mode; a non-low-power mode; a WiFi on/connected mode; a WiFi off mode; a Bluetooth™ on mode; a Bluetooth™ off mode; a charging mode; or another suitable mode.

Variations of Steps S124, S126, S128 can be combined with each other and/or with other suitable steps. For instance an exemplary method can include: at the user device, performing a check for signal strength; buffering the processing operation upon detection of at least one of signal strength above a threshold level and movement of the user device; and initiating charging of the electric vehicle in response to verification of parameters according to Step S120. Variations of the method can further include controlling operational states of the user device (e.g., transitioning the user device from a first mode with a lower degree of connectivity to a second mode with a higher degree of connectivity to initiate charging, and then back to the lower degree of connectivity to conserve battery use).

Additional method steps can include one or more of:

Providing a tool at the user interface by which the user can report an issue with the EVSE unit. In an example, the tool can include a button or other input region at a detail page (e.g., station detail page) of the user interface, which allows users to select a reason for the issue and to report it to the platform. After the charger issue report is received, the software network provider can take remote action to troubleshoot the unit, in order to restore it to working operational mode.

Implementing automatic error detection and hardware restart operation modes when a user plugs in their electric vehicle to the EVSE unit, and if the automatic remote restart fails, recommending and/or directing the user to a nearby alternative EVSE unit that is operational.

Providing a tool for saving an identifier of the EVSE (e.g., station ID) at the user device, an alert to the user that their charging session will automatically start after connections with the telecommunications network are restored.

Displaying a warning message when the user plugs into an incorrect EVSE unit/charger, and providing a notification with instructions for plugging the electric vehicle into another compatible charger instead.

Variations of the method 100 can include other suitable steps.

2.4 Method-Charging with Load Management Benefits in Offline Connectivity Modes

Embodiments, variations, and examples of the methods 100 described can provide solutions to low connectivity or offline modes of EVSE units and/or user devices, in a manner that still allows for energy optimization and load management of charging associated with a set of EVSE units at a site, any EVSE unit, or any group of EVSE units. As such, the methods described can continue to provide solutions for energy optimization in response to demand response events and/or other situations, described in Applications incorporated by reference.

One embodiment of load management an energy optimization can include: establishing an interface with a management entity (e.g., site host of a set of chargers) of an electric power distribution system, the electric power distribution system in communication with a set of outlets of utility-facing devices providing access to the electric power distribution system S110; returning a demand assessment from a demand model characterizing anticipated demand upon the one or more portions of the electric power distribution associated with the set of outlets S120; and executing an action for adjustment of load distribution through the management entity, based upon the demand assessment S130. Embodiments, variations, and examples of executed actions contributing to improved load distribution based upon demand (e.g., actual demand, anticipated demand) are described in U.S. application Ser. No. 17/698,449 filed on Mar. 18, 2022, which is herein incorporated in its entirety by this reference, as well as other Applications incorporated by reference.

The method 100 can, however, include other suitable steps to promote proper load distribution in response to various events.

### 3. System

As shown in FIG. 5, an embodiment of a system 200 for charging includes: a platform 210 for charging, comprising a charging session processing subsystem 212 and a load distribution subsystem 214; a user device 220; an EVSE unit 230; and a telecommunications network 240 connecting the user device 220 to the platform 210. The telecommunications network 240 can also connect the EVSE unit 230 to the platform.

The system 200 is configured to execute one or more portions of the methods 100 described in Sections 2.1-2.4 above, and/or other suitable methods. Aspects of the system 200 are described in Applications incorporated by reference.

The system 200 can, however, include other suitable elements configured to enable charging sessions in offline modes of the user device and/or EVSE unit.

### 4. Computer Systems

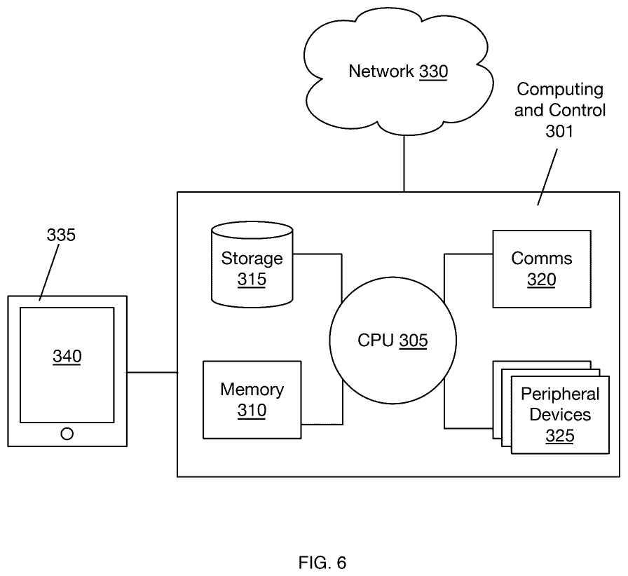

The present disclosure provides computing and control subsystems that are programmed to implement methods described. FIG. 6 shows a computing and control subsystem 301 that is programmed or otherwise configured to, for example, facilitate charging of an electric vehicle, according to methods described.

The computing and control subsystem 301 includes architecture for regulating various aspects of detecting a check-in request and verification of parameters of the check-in request, in order to enabling charging of an electric vehicle, according to functionalities of the present disclosure described. The computing and control subsystem 301 can be an electronic device of a user or a computer system that is remotely located with respect to the electronic device. The electronic device can be a mobile electronic device.

The computing and control subsystem 301 includes a central processing unit (CPU, also “processor” and “computer processor” herein) 305, which can be a single core or multi core processor, or a plurality of processors for parallel processing. The computing and control subsystem 301 also includes memory or memory location 310 (e.g., random-access memory, read-only memory, flash memory), electronic storage unit 315 (e.g., hard disk), communication interface 320 (e.g., network adapter) for communicating with one or more other systems, and peripheral devices 325, such as cache, other memory, data storage and/or electronic display adapters. The memory 310, storage unit 315, interface 320 and peripheral devices 325 are in communication with the CPU 305 through a communication bus (solid lines), such as a motherboard. The storage unit 315 can be a data storage unit (or data repository) for storing data. The computer system 301 can be operatively coupled to a computer network (“network”) 330 with the aid of the communication interface 320. The network 330 can be the Internet, an internet and/or extranet, or an intranet and/or extranet that is in communication with the Internet.

In some embodiments, the network 330 is a telecommunication and/or data network. The network 330 can include one or more computer servers, which can enable distributed computing, such as cloud computing. For example, one or more computer servers may enable cloud computing over the network 330 (“the cloud”) to perform various aspects of facilitating charging of an electric vehicle, with desired security, authentication, and locking functionalities associated with various types of charging sessions and/or different users. Such cloud computing may be provided by cloud computing platforms such as, for example, Amazon Web Services (AWS), Microsoft Azure, Google Cloud Platform, and IBM cloud. In some embodiments, the network 830, with the aid of the computer system 601, can implement a peer-to-peer network, which may enable devices coupled to the computer system 101 to behave as a client or a server.

The CPU 305 can include one or more computer processors and/or one or more graphics processing units (GPUs). The CPU 305 can execute a sequence of machine-readable instructions, which can be embodied in a program or software. The instructions may be stored in a memory location, such as the memory 310. The instructions can be directed to the CPU 305, which can subsequently program or otherwise configure the CPU 305 to implement methods of the present disclosure. Examples of operations performed by the CPU 305 can include fetch, decode, execute, and writeback. The CPU 305 can be part of a circuit, such as an integrated circuit. One or more other components of the computing and control subsystem 301 can be included in the circuit. In some embodiments, the circuit is an application specific integrated circuit (ASIC).

The storage unit 315 can store files, such as drivers, libraries and saved programs. The storage unit 315 can store user data, e.g., user preferences and user programs. In some embodiments, the computer system 301 can include one or more additional data storage units that are external to the computer system 301, such as located on a remote server that is in communication with the computer system 301 through an intranet or the Internet.

The computing and control subsystem 301 can communicate with one or more remote computer systems through the network 330. For instance, the computer system 601 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), smart watches, or personal digital assistants. The user can access the computer system 601 via the network 330.

Methods as described herein can be implemented by way of machine (e.g., computer processor) executable code stored on an electronic storage location of the computing and control subsystem 301, such as, for example, on the memory 310 or electronic storage unit 315. The machine executable or machine-readable code can be provided in the form of software. During use, the code can be executed by the processor 305. In some embodiments, the code can be retrieved from the storage unit 315 and stored on the memory 310 for ready access by the processor 305. In some situations, the electronic storage unit 315 can be precluded, and machine-executable instructions are stored on memory 310.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Embodiments of the systems and methods provided herein, such as the computing and control subsystem 301, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, or disk drives, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computing and control subsystem 301 can include or be in communication with an electronic display 335 that comprises a user interface (UI) 340 for providing, for example, a visual display indicative of statuses associated with charging of an electric vehicle, security information, verification information, and other information. Examples of UIs include, without limitation, a graphical user interface (GUI) and web-based user interface.

Methods and systems of the present disclosure can be implemented by way of one or more algorithms. An algorithm can be implemented by way of software upon execution by the central processing unit 305. The algorithm can, for example, facilitate charging of an electric vehicle, with desired security, verification, and other functionalities associated with various types of charging sessions and/or different users.

Additionally or alternatively, the computing and control subsystem 801 can include architecture with programming to execute other suitable methods.

### 5. Conclusion

Embodiments of the invention(s) described can include every combination and permutation of the various system components and the various method processes, including any variants (e.g., embodiments, variations, examples, specific examples, figures, etc.), where portions of embodiments of the method 100 and/or processes described herein can be performed asynchronously (e.g., sequentially), concurrently (e.g., in parallel), or in any other suitable order by and/or using one or more instances, elements, components of, and/or other aspects of the system 200 and/or other entities described herein.

Any of the variants described herein (e.g., embodiments, variations, examples, specific examples, figures, etc.) and/or any portion of the variants described herein can be additionally or alternatively combined, aggregated, excluded, used, performed serially, performed in parallel, and/or otherwise applied.

Portions of embodiments of the invention(s) can be embodied and/or implemented at least in part as a machine configured to receive a computer-readable medium storing computer-readable instructions. The instructions can be executed by computer-executable components that can be integrated with embodiments of the system(s). The computer-readable medium can be stored on any suitable computer-readable media such as RAMs, ROMs, flash memory, EEPROMs, optical devices (CD or DVD), hard drives, floppy drives, or any suitable device. The computer-executable component can be a general or application specific processor, but any suitable dedicated hardware or hardware/firmware combination device can alternatively or additionally execute the instructions.

As a person skilled in the art will recognize from the previous detailed description and from the figures and claims, modifications and changes can be made to embodiments of the inventions, and/or variants without departing from the scope defined in the claims. Variants described herein not meant to be restrictive. Certain features included in the drawings may be exaggerated in size, and other features may be omitted for clarity and should not be restrictive. The figures are not necessarily to scale. The absolute or relative dimensions or proportions may vary. Section titles herein are used for organizational convenience and are not meant to be restrictive. The description of any variant is not necessarily limited to any section of this specification.

Furthermore, it should be understood from the foregoing that, while particular implementations have been illustrated and described, various modifications may be made thereto and are contemplated herein. It is also not intended that the invention be limited by the specific examples provided within the specification. While the invention has been described with reference to the aforementioned specification, the descriptions and illustrations of the preferable embodiments herein are not meant to be construed in a limiting sense. Furthermore, it shall be understood that all aspects of the invention are not limited to the specific depictions, configurations or relative proportions set forth herein which depend upon a variety of conditions and variables. Various modifications in form and detail of the embodiments of the invention will be apparent to a person skilled in the art. It is therefore contemplated that the invention shall also cover any such modifications, variations and equivalents. It is intended that the following claims define the scope of the invention and that methods and structures within the scope of these claims and their equivalents be covered thereby.

What is claimed is:

1. A method for charging an electric vehicle at an Electric Vehicle Service Equipment (EVSE) unit, the method comprising:
when the EVSE unit is in a first location providing a first level of connectivity with a network below a threshold:
at a first time point, receiving a check-in request at the EVSE unit by a user associated with the electric vehicle, wherein the check-in request comprises a communication between the EVSE unit and a user device of the user, the communication comprising a set of identifying parameters;
upon verification of the set of identifying parameters of the check-in request, initiating charging of the electric vehicle, through a cable coupled between the EVSE unit and the electric vehicle, at a second time point later than the first time point.

2. The method of claim 1, wherein receiving the check-in request comprises promoting communication between a radio-frequency identification (RFID) element of the user device of the user, and the EVSE unit.

3. The method of claim 1, wherein receiving the check-in request comprises promoting communication between a near-field communication (NFC) element of the user device of the user, and the EVSE unit.

4. The method of claim 1, wherein receiving the check-in request comprises detecting a tag scanning event.

5. The method of claim 1, wherein verification of the set of identifying parameters comprises verifying the set of identifying parameters when the user device returns to a second location providing a second level of connectivity with the network above the threshold.

6. The method of claim 5, wherein the second time point comprises a time point during which the user device is at the second location and the EVSE unit is at the first location.

7. The method of claim 1, wherein verification of the set of identifying parameters of the check-in request comprises communicating the set of identifying parameters through the network using a Subscriber Identity Module (SIM) component with a wired connection to a second location having a level of connectivity to the network above the threshold.

8. The method of claim 1, wherein the set of identifying parameters is communicated through the network upon scanning a tag coupled to the EVSE unit.

9. The method of claim 8, wherein verification of the set of identifying parameters of the check-in request comprises buffering of the scan of the tag until the user device is transitioned out of an offline mode to a connected mode characterized by connection with the network.

10. The method of claim 8, wherein scanning the tag comprises scanning the tag with a user interface of a mobile application executing on the user device, and upon detection that the user device is in an offline mode, the mobile application comprises architecture for presenting the user with the option to initiate charging automatically once the user device is in an online mode.

11. The method of claim 9, wherein buffering of the scan comprises increasing a frequency of buffering in response to detection of movement of the user device.

12. The method of claim 9, wherein buffering of the scan comprises increasing a frequency of buffering in response to transitioning of the user device from an offline mode to a WiFi-connected mode.

13. A method for charging an electric vehicle at an Electric Vehicle Service Equipment (EVSE) unit, the method comprising:
when the EVSE unit and a user device of the user are at a first location providing a level of wireless connectivity with a network below a threshold:
at a first time point, receiving a check-in request at the EVSE unit by a user associated with the electric vehicle, wherein the check-in request comprises a communication between the EVSE unit and a mobile device of the user, the communication comprising a set of identifying parameters;
upon verification of the set of identifying parameters of the check-in request, initiating charging of the electric vehicle, through a cable coupled between the EVSE unit and the electric vehicle, when both the user device and the EVSE unit remain at the first location.

14. The method of claim 13, wherein verification of the set of identifying parameters of the check-in request comprises communicating the set of identifying parameters using a Subscriber Identity Module (SIM) component with a wired connection to a location with a level of connectivity to the network above the threshold.

15. The method of claim 13, wherein receiving the check-in request comprises promoting communication between at least one of a radio-frequency identification (RFID) element and a near-field communication (NFC) element of the user device of the user, and the EVSE unit.

16. The method of claim 13, wherein the user device comprises a badge associated with a fleet operation.

17. The method of claim 13, wherein the user device comprises a lodging key.

18. The method of claim 13, wherein receiving the check-in request comprises detecting manual entry of an authentication code at a user interface of at least one of the user device and the EVSE unit.

19. The method of claim 13, wherein receiving the check-in request comprises detecting a tag scanning event involving scanning of a tag.

20. The method of claim 19, wherein the tag comprises at least one of a barcode and a quick response (QR) code.
